(19) United States
(12) Patent Application Publication
(10) Pub. No.: US 2017/0050710 A1
(43) Pub. Date: Feb. 23, 2017

(54) MANAGING DIVING ACTIVITIES BY WIRELESS DATA COMMUNICATION

(71) Applicant: Amir Emad Fakhry GERGES, CAIRO (EG)

(72) Inventor: Amir Emad Fakhry GERGES, CAIRO (EG)

(21) Appl. No.: 15/118,856

(22) PCT Filed: Feb. 13, 2015
(86) PCT No.: PCT/IB2015/051087

§ 371 Date: Aug. 12, 2016

(30) Foreign Application Priority Data
Feb. 13, 2014 (GB) 1402520.9

(51) Int. Cl. B63C 11/02; G06K 7/10; G06Q 30/04; G06F 1/26

(52) U.S. Cl. CPC B63C 11/02; G06F 1/266; G06K 7/10297; G06K 7/10366; G06Q 30/04; B63C 2011/021

(57) ABSTRACT

A portable diver device (100) for managing diving activities for a diver, wherein the portable diver device (100) comprises at least one data storage unit (102) storing identification data being indicative of an identity of the diver and optionally storing diving related data related to the diver, and a wireless data communications interface (104) configured for wirelessly communicating at least one of the group consisting of the identification data and the diving related data with a diving activities management apparatus (120, 130, 140), when the portable diver device (100) is in sufficient spatial vicinity of the diving activities management apparatus (120, 130, 140).

The invention relates to a portable diver device, in particular a dive computer and/or a dive data logger and/or a diver tag.

Moreover, the invention relates to a diving activities management apparatus.

The invention relates to a diving equipment.

Furthermore, the invention relates to an arrangement.

The invention also relates to methods of managing diving activities for divers.

Beyond this, the invention relates to a program element.

Furthermore, the invention relates to a computer-readable medium.

Conventionally, divers in a diver center are managed manually. The current dive data logging is done mainly by manual input. Divers enroll themselves using paper lists, optionally supported by simple computer programs. Furthermore, also the management of diver equipment such as dive tanks or the like are managed based on paper lists which may be supported by computers. After a dive, the divers are counted on the boat one by one by a dive coach.

However, such a conventional management of a dive center is cumbersome and lacks safety.

It is an object of the invention to provide an efficient and safe way of managing divers in a dive related setting (such as a dive center, a dive resort and/or a dive boat).

In order to achieve the object defined above, a portable diver device, a diving activities management apparatus, a diving equipment, an arrangement, methods of managing diving activities for a diver, a program element, and a computer-readable medium according to the independent claims are provided.

According to an exemplary embodiment of the invention, a portable diver device for managing diving activities for a diver is provided, wherein the portable diver device comprises at least one data storage unit (such as an electronic memory, or a physical structure carrying optically readable code permanently or temporarily) storing identification data being indicative of an identity of the diver and optionally storing diving related data related to the diver (it is possible to store the identification data and the diving related data in one common data storage unit; it is alternatively possible to store the identification data and the diving related data in two or more separate data storage units, for instance the identification data in an NFC chip memory and the dive related data in a separate memory), and a wireless data communications interface configured for wirelessly communicating at least one of the group consisting of the identification data and the diving related data with a diving activities management apparatus (particularly only) when the portable diver device is in sufficient spatial vicinity of the diving activities management apparatus.

According to another exemplary embodiment of the invention, a diving activities management apparatus for managing diving activities for a plurality of divers is provided, wherein the diving activities management apparatus comprises a database storing data sets for each of the divers, wherein each data set comprises identification data being indicative of an identity of the respective diver and assigned diving related data related to the respective diver, a wireless data communications interface configured for wirelessly communicating at least one of the group consisting of the identification data and the diving related data with a plurality of portable diver devices each assigned to a respective one of the divers (particularly only) when the respective portable diver device is in sufficient spatial vicinity of the diving activities management apparatus, and a processor configured for processing the stored and the communicated data for managing the diving activities for the plurality of divers.

According to still another exemplary embodiment of the invention, a diving equipment for a diver is provided, wherein the diving equipment comprises a functional dive component providing a dive related function during a dive of the diver, a data storage unit storing identification data being indicative of an identity of the diver, and a wireless data communications interface configured for wirelessly communicating the identification data with one of the group consisting of a diving activities management apparatus, and a portable diver device, when the diving activities management apparatus or the portable diver device is in sufficient spatial vicinity of the diving equipment.

According to yet another exemplary embodiment of the invention, an arrangement for managing diving activities for a plurality of divers is provided, wherein the arrangement comprises a diving activities management apparatus having the above mentioned features, and a portable diver device having the above mentioned features, wherein the diving activities management apparatus and the portable diver device are communicatively coupled for wireless data transfer for managing diving activities for the diver when the diving activities management apparatus is in sufficient spatial vicinity of the portable diver device.

According to yet another exemplary embodiment of the invention, a method of managing diving activities for a diver is provided, wherein the method comprises storing identification data being indicative of an identity of the diver and storing diving related data related to the diver on a data storage unit of a portable diver device, and wirelessly communicating at least one of the group consisting of the identification data and the diving related data between a wireless data communications interface of the portable diver device and a diving activities management apparatus (particularly only) when the portable diver device is in sufficient spatial vicinity of the diving activities management apparatus.

According to still another exemplary embodiment of the invention, a method of managing diving activities for a plurality of divers is provided, wherein the method comprises storing data sets for each of the divers in a database of a diving activities management apparatus, wherein each data set comprises identification data being indicative of an identity of the respective diver and assigned diving related data related to the respective diver, wirelessly communicating at least one of the group consisting of the identification data and the diving related data between a wireless data communications interface of the diving activities management apparatus and a plurality of portable diver devices each assigned to a respective one of the divers when the respective portable diver device is in sufficient spatial vicinity of the diving activities management apparatus, and processing the stored and the communicated data by a processor of the diving activities management apparatus for managing the diving activities for the plurality of divers.

According to still another exemplary embodiment of the invention, a program element (for instance a software routine, in source code or in executable code) is provided, which, when being executed by a processor (such as a microprocessor or a CPU), is adapted to control or carry out a method having the above mentioned features.

According to yet another exemplary embodiment of the invention, a computer-readable medium (for instance a CD, a DVD, a USB stick, a floppy disk or a hard disk) is provided, in which a computer program is stored which, when being executed by a processor (such as a microprocessor or a CPU), is adapted to control or carry out a method having the above mentioned features.

Data processing which may be performed according to embodiments of the invention can be realized by a computer program, that is by software, or by using one or more special electronic optimization circuits, that is in hardware, or in hybrid form, that is by means of software components and hardware components.

In the context of the present application, the term “managing diving activities” may particularly denote performing tasks related to the organization of dives for a diver at a dive center. This may involve enrolment, rental of equipment, participation at one or more dives, documenting one or more dives and/or billing for one or more divers at a dive center.

In the context of the present application, the term “identification data” may particularly denote that a data item which identifies a diver, for instance by the diver's name, a unique identifier allowing to unambiguously distinguish the diver from all other divers at the dive center, etc.

In the context of the present application, the term “diving related data” may particularly denote that any data being assigned to a specific diver in terms of the management of this diver's diving activities at the dive center.

In the context of the present application, the term “wireless data communications interface” may particularly denote a combination of a physical interface (being configured for exchanging data wirelessly with another communicatively coupled entity, for instance an antenna) with the capability of communicating with another communicatively coupled entity in accordance with a certain wireless communication protocol (such as an NFC protocol or an RFID protocol). Other technologies of wireless transmission, like low energy Bluetooth 4.0 of Wi-Fi may be implemented as well in exemplary embodiments. However, also a permanent physical structure (such as a piece of fabric or any other substrate) carrying machine-readable code such as an optically readable code can be considered as a wireless data communications interface, since it can be read out by a machine such as an optical reader. Such a machine-readable code, for instance optically readable code, can also be displayed on a display of a device such as a dive computer, thereby constituting a wireless data communications interface.

In the context of the present application, the term “when one entity is in sufficient spatial vicinity of another entity” may particularly denote that the wireless data communication interfaces of the entities are configured so that wireless data communication via the wireless data communication interfaces of the entities is triggered by (or is not enabled before) the event of the two entities approaching one and other up to or even below such a small mutual distance that the exchange of data between these two entities becomes possible in terms of a corresponding communication protocol (such as an NFC protocol).

According to an exemplary embodiment, a wirelessly communicating communication system is provided in which all data generated in terms of diving activities of divers at a dive center can be communicated between different communication nodes in an efficient, a safe and a reliable way. Communication of the data for a group of divers is based on the assignment of a (preferably) unique identifier to each of the divers. Advantageously, different nodes of the communication system may be triggered to start or initiate transfer of data when the distance between two communication partner devices falls below a threshold value (corresponding to a spatial range over which communication is possible, or simply corresponding to a distance at which a human user carrying one of these communication partner devices is at a distance to actually touch the other communication partner device to thereby start the data transfer). With such a communication concept, the whole diving center may be organized for even a large number of divers without the need to extensively produce paper documents and with reduced manpower while guaranteeing a high degree of data safety. The latter is achieved by giving a user the power to initiate data communication, since the user has to reduce the distance between his portable device and a data destination apparatus to which data shall be transferred. This communication concept is also particularly appropriate for the environment of diving centers, i.e. aqueous, sandy and harsh conditions. The system is capable of integrating devices operating in an office, at the beach, on a boat, and also with a submerging diver.

In the following, further exemplary embodiments of the portable diver device, the diving activities management apparatus, the diving equipment, the arrangement, the methods of managing diving activities for a diver, the computer-readable medium and the program element will be described.

In an embodiment, the data storage capacity of the data storage unit of the device (and/or of the diving equipment) should be so that a unique identifier and/or sufficient diving related data may be stored in this data storage unit. For example, the storage capacity thereof may be at least 100 Bytes, in particular at least 1 kB, more particularly at least 10 kB, even more particularly at least 1 MB. For example, when embodied as an NFC chip device, the device may use the entire data storage capacity (for instance in a range between 40 Bytes and 1000 Bytes, in particular more than 100 Bytes) of the NFC chip memory for storing the identification data and for storing software for a pairing process. When however embodied as a data logger or a dive computer, the device may be provided with a storage capacity for storing both the identification data and the dive related data (in particular at least 1 kB, more particularly at least 10 kB). It is also possible to provide a device which has an NFC chip memory storing the identification data, and has an additional memory storing the dive related data.

The data storage capacity of the database of the apparatus may be larger than that of the data storage unit of the device. For example, the storage capacity of the database of the apparatus may be at least 1 MB, in particular at least 10 MB, more particularly at least 1 GB.

In an embodiment, it is also possible to capture the dive data log directly from the dive logger or dive computer as the collection of these data is important for safety and research.

In an embodiment, the diving activities management apparatus and the portable diver device are configured to initiate data communication by a user carrying the portable diver device and reducing a distance between the portable diver device and the diving activities management apparatus to fall below about 10 cm, more particularly to fall below about 5 cm. These maximum distance values are in accordance with NFC technology. Even more particularly, the initiation of the data exchange needs to be triggered by the user by touching the diving activities management apparatus in a specific embodiment.

In an embodiment, the wireless data communications interface is configured for wirelessly communicating the data by one of the group consisting of Near Field Communication, and Radio Frequency Identification. In the context of this application, the term “Near field communication” (NFC) may particularly denote a set of standards for electronic devices to establish radio communication with each other by touching them together or bringing them into proximity, usually no more than a few inches. Communication is also possible between an NFC device and an unpowered NFC chip, called a “tag”. NFC allows a two-way communication between endpoints, whereas systems according to other embodiments such as contactless smart cards are one-way only.

In an embodiment, the device is configured to be wearable by or attachable to a body of the diver. Thus, a close physical connection may be ensured between the device (carrying the unique identifier unambiguously identifying the user) and the body of the diver. This prevents misuse and guarantees data safety.

In an embodiment, the device is configured as one of the group consisting of a tag, a bracelet, a watch, and a dive computer. Such a tag may be an NFC tag or an RFID tag. With a bracelet, watch or dive computer, one or more sensors (such as temperature sensors, pressure sensors, etc.) may be provided for sensing dive related data during a dive. Such data may be stored on a data storage unit of the device, for instance for documentation purposes. With a dive computer, it is additionally possible to process the sensed data, for instance to display a safe dive procedure to the diver during the dive.

In an embodiment, the device is configured to be waterproof and/or dive pressure resistant. For instance, the device may be provided with a casing which does not allow water to enter into an interior of the device. The robustness of the casing of the device may be selected so that it withstands pressure values occurring during diving, for instance up to 30 bar or up to 100 bar.

In an embodiment, the device comprises at least one sensor configured for sensing dive related data during a dive of the diver and for storing the sensed data in the data storage unit. Such sensors may comprise pressure sensors, temperature sensors, time sensors, etc. Also when embodied as a diver tag, the device may comprise one or more of such sensor.

In an embodiment, the device comprises a processor configured for processing the sensed data and for presenting the result of the processing to the diver. The result may be presented to the user via a display of the device such as an LCD. Additionally or alternatively, the processor may be also be configured for controlling the wireless data exchange.

In an embodiment, the device comprises a rechargeable accumulator being configured for supplying electric energy to the device (in a normal operation mode) and for being wirelessly charged with electric energy from the apparatus (in a charging operation mode). The transfer of energy for charging may be performed in particular via the wireless data communications interface (for instance via an inductive coupling). A charging procedure may be initiated when the device is in sufficient spatial vicinity of the apparatus, in particular by a user carrying the device and touching the diving activities management apparatus and/or getting in the field of a wireless charging station, whether using inductive or resonant wireless charging technologies. Thus, sequentially or simultaneously with the data transfer, the wireless coupling of the device with the apparatus may also be used for charging the rechargeable accumulator of the device with electric energy. In an embodiment, the rechargeable accumulator remains unsubstituted within the device over its entire lifetime. In another embodiment, it is also possible to temporarily remove the rechargeable accumulator from the device, for instance by external charging or for maintenance.

In an embodiment, the device comprises an additional substitutable accumulator being configured for supplying electric energy to the device and for being substituted when discharged. According to such an embodiment, the apparatus may comprise two sources of electric energy, i.e. the above-mentioned rechargeable accumulator as well as the additional substitutable accumulator. By such a dual-power configuration, one normal battery may be provided which lasts for long time (for example one year), and another rechargeable battery may be provided that charges wirelessly. This also increases the safety during a dive. By combining both energy supply mechanisms it is possible to overcome conventional limitations when using one single powering system. In an embodiment, the substitutable accumulator may only be activated for providing electric power in a scenario in which it is determined that the rechargeable accumulator does not provide sufficient electric energy, for instance due to a low charging level.

In an embodiment, the wireless data communications interface is configured for enabling the wireless communication with the diving activities management apparatus only when a distance between the portable diver device and the diving activities management apparatus has fallen below a predefined threshold value, in particular has fallen below about 10 cm, more particularly has fallen below about 5 cm. Hence, it can be ensured that a data transfer can only be carried out when this is actually intended by the user. Thus, data safety is guaranteed.

In an embodiment, the wireless data communications interface is configured for wirelessly communicating with wireless data communications interfaces of a plurality of dive route indicating markers to be arranged along a dive route so that, when a diver carrying the portable device in sufficient spatial vicinity of (in particular touches) a corresponding one of the markers, dive route information (such as a position of the marker along a dive route or an identifier of the respective marker) is transmitted from the wireless data communications interface of the respective marker to the wireless data communications interface of the device. The device may comprise a processor configured for processing the communicated dive route information for presenting the result of the processing to the diver via a display. A dive route underwater may be indicated to a diver by a plurality of properly visible markers directing the divers along the dive route to give the diver a proper orientation. Each of the markers may be provided with a wireless data communication interface, in particular with an NFC chip. When the diver approaches one of the markers (or more specifically touches a marker) while diving along the dive route, this may trigger data exchange between the marker and the device carried by the user. For instance, a marker may communicate identification information identifying the marker or may communicate position information identifying the position of the marker along the dive route. The processor of the device may use the data communicated by the markers while the diver dives along the dive route, may calculate in real-time a current position or trajectory of the diver along the dive route, and may display a map of the dive route together with a current position of the diver on the display of the device. Thus, it is possible to use NFC tags underwater as a source of information and safety where some tags can be put inside underwater caves or wrecks or any other dive site. The diver can touch the tag with the dive computer, and the latter displays information regarding a dive route (such as a route of an exciting cave or information about an area in the wreck, etc.).

In an embodiment, the apparatus is configured as at least one of the group consisting of a tablet, a laptop, a desktop computer, and a mobile phone. The integration of the capability of the apparatus into other electronic appliances is also possible. One further example for a configuration of an apparatus according to an exemplary embodiment of the invention are glasses such as augmented reality glasses or smart glasses which may be equipped with wireless communication capability (and optionally processing capabilities).

In an embodiment, the processor is configured for determining whether each diver of a group of divers has communicated its presence, in particular after a dive, via the wireless data communications interface. Hence, each of the divers returning from a dive has to move her or his assigned device to the apparatus to initiate communication, so that the apparatus receives the information that the diver corresponding to the unique identifier has returned safely from the dive. This prevents safely that any diver is left behind at the end of the dive. In an embodiment, the system may also check if a diver went diving without scanning her or his tag first by checking the number of scanned divers against the number of divers registered for the dive, and can produce for example an audible and/or visual alarm and prevent the dive guide or another responsible person from starting the dive before finding the unscanned diver.

In an embodiment, the processor is configured for determining billing data for a respective diver being indicative of an amount of money to be paid for the diver's diving activities. Thus, with each cost generating activity of the diver (for instance rental of dive equipment, participation at a dive excursion, supply with a tag, etc.), corresponding billing data may be directly stored in the data storage unit or the database of the device or apparatus. This simplifies the billing procedure and renders it less prone to failure. When the diver is present in a resort or the like, the same unique identifier given to the diver may be used for other billing transactions, and one combined billed can be given at the end (for instance, a check for ordered food can be signed by scanning the device carrying the unique identity, and the device may be used as well for accessing a room in the resort).

Possible management tasks of the apparatus will be summarized in the following: In an embodiment, the processor is configured for determining a dive protocol for a respective diver being indicative of dive parameters of the at least one dive of the diver. Additionally or alternatively, the processor may be configured for determining a list of dive equipment supplied to a respective diver. Additionally or alternatively, the processor may be configured for processing enrolment data of a diver for enrolling the diver. In this context, it is also possible to make use of an RFID chip in an electronic passport (e-passport). Additionally or alternatively, the processor may be configured for generating and assigning the identification data to the diver and communicating the assigned identification data to the portable diver device to be stored on the data storage unit of the portable diver device. In an embodiment of the device, the data storage unit and the wireless data communications interface are configured as an optically readable structure (such as a code being readable by a one-dimensional or a two-dimensional barcode reader). Such a code may be in particular a barcode (i.e. a one dimensional barcode) or a QR code (i.e. a two-dimensional barcode). The code may encode the identification data and the diving related data so that an optical reader (i.e. a one-dimensional barcode reader or a two-dimensional barcode reader) of the diving activities management apparatus is capable of optically reading at least one of the identification data and the diving related data from the optically readable structure, when the optically readable structure is in sufficient spatial vicinity (so as to enable a cooperation of optically readable structure and optical reader, for instance less than 10 cm) of the optical reader.

In a corresponding embodiment of the apparatus, the wireless data communications interface of the apparatus may comprise (for instance may additionally have an NFC chip) or may consist of (i.e. has only) an optical reader (such as a barcode reader, wherein a camera of a mobile phone or a tablet PC can be used to provide the barcode reader function) capable of optically reading at least one of the identification data and the diving related data from an optically readable structure, in particular a barcode or a QR code, of a respective one of the plurality of portable diver devices when the optically readable structure is in sufficient spatial vicinity of the optical reader.

Reading a barcode also requires a certain spatial vicinity between barcode reader and barcode, for instance less than 10 cm or the like. Thus, it is also possible that a one-dimensional barcode or a two-dimensional barcode encodes the diver's identity and assigned diving related data. A corresponding device may have a bracelet or the like carrying the optically readable structure which may be printed, in a user defined manner specifically for certain user, on a substrate such as a bracelet.

Such an embodiment may be applied to a scenario in which it is desired to have a system for a diving base/boat that actually identifies the divers—who goes in an who goes out. Barcode or QR codes (or similar technologies) may be used for that purpose. It is possible to read these codes with any phone or tablet, and it is very cheap to make the tags (for instance, it is possible to just print them on a plastic card). The QR code also may include then the name of the diver, etc. The QR code can also be generated by a dive computer and displayed on the screen. The QR code can include the diver's name, but also for instance maximum depth, dive time and average depth. That can be implemented in dive computers with a color screen, and readout is simple.

More generally, an embodiment of the invention relates to a diver management system comprising a reader that reads tags worn by a diver, preferable when entering and preferable also when exiting the water.

In an embodiment, the functional dive component is configured as a dive tank. Other functional dive components are a mouthpiece, a regulator, a buoyancy compensator device, a head-up display, etc. More generally, each dive component rented by a diver from a dive center and providing a functional contribution during diving may be foreseen with a tag.

In an embodiment, the data storage unit and the interface form at least part of a tag, in particular an NFC tag or an RFID tag, attached to the functional dive component. By such an attachment, the dive equipment becomes capable of being communicatively coupled to the other NFC or RFID devices and/or apparatuses so that the inventory of the dive equipment of the dive center may be integrated into the architecture of exemplary embodiment of the invention.

In an embodiment, the diving activities management apparatus and the portable diver device are configured to initiate data communication by a user carrying the portable diver device and touching the diving activities management apparatus. In other words, data transfer (and/or recharging) can be blocked or inhibited until the touching action has been performed and detected. Thus, a user maintains the full control to initiate a data and/or energy transfer which is advantageous in terms of data safety.

Different wireless technologies, not only NFC, can be used for exemplary embodiments of the invention. For instance, Bluetooth-based technologies may be implemented (such as the iBeacon® feature of Apple®). Other present or future communications protocols, for instance for implementations in cell phones, etc., may be used as well for exemplary embodiments. A suitable alternative, that can be implemented to get the same or very similar results, is using chips which can be attached to the diver. For instance, there can be a mattress on a boat used for a dive excursion, so when the diver walks over it (entering or leaving the boat), the diver is registered automatically. Such a mattress is an example for an apparatus according to an embodiment of the invention.

In an embodiment, it is possible that an apparatus or a device (for instance embodied as dive computer) can be adjusted through a mobile device app.

In yet another embodiment, it is possible that a device and a dive equipment configured as a dive tank are communicatively coupled so as to provide the device with information regarding the remaining gas (such as air, helium, or oxygen used by the diver for diving) within the dive tank, during a dive. The device may have, for this purpose, a first wireless communication interface (for instance an NFC interface). Correspondingly, the dive equipment or a tag (which may be denoted as a wireless tank transmitter) attached thereto may also have a first wireless communication interface (for instance also an NFC interface) for communication with the first wireless communication interface of the device. Additionally, the device may have a second wireless communication interface (for instance a Bluetooth interface) communicatively coupled to a second wireless communication interface of the dive equipment or tag attached thereto (for instance also a Bluetooth interface). The dive equipment or tag attached thereto may furthermore have a sensor for detecting the present gas level within the tank. When the user carrying the device sufficiently approaches or even touches the dive tank or tag attached thereto, the pair of first wireless communication interfaces may initiate automatic pairing of the two second wireless communication interfaces. This may trigger the present gas level to be transmitted from the dive equipment to the device, where it can be displayed on a display to the device. Such an embodiment may overcome shortcomings of conventional systems having the problem that if more than one diver starts a pairing procedure at the same time, there is the risk that the signal goes to the wrong receiver which can cause a safety issue.

In yet another embodiment, it is possible to provide an accessory that gets attached to an already available dive computer and that adds a wireless data connectivity capability to it without building a complete computer. Hence, components of devices or apparatuses according to embodiments of the invention may be provided as add-on kits or retrofit equipment to be added to existing devices or apparatuses.

In an embodiment of the apparatus, it is possible that the latter, when being configured as a diver counting module, counts automatically the divers and checks who dived and who did not dive, for instance by checking the number of divers who scanned before diving and the actual divers that were scanned when they boarded the diving boat.

In an embodiment, a device having implemented a mobile app using the wireless connection can offer a user the opportunity to modify the dive computer setup, like for example date, time, time intervals at which data gets logged, composition of different gas mixes and dive plan, etc. Hence, instead of having to press lots of buttons on the dive computer with the inconvenience for a user to start from the beginning if the user misses a desired option, that saves time and is more user friendly.

In an embodiment, the diving managing apparatus has the option of feedback questionnaires and scientific surveys that gets triggered automatically after the dive, as part of every dive or if there was something interesting that was discovered in the dive profile like for example rapid ascent, certain depth reached, air tank pressure falls below a certain level, etc. Hence, the answers also can be used in research.

In an embodiment of the device, also before starting breathing from a certain tank, tank mixture details can be shown on a display of the device (in particular when configured as a dive computer) so that the diver can double check if it is the correct mix or not. This improves the safety for a diver, since, if a diver breathes from a wrong mix at a wrong depth, it can cause the diver to die. Also, such an embodiment may be used to directly set up a gas mixture in the dive computer settings without the need of inputting a lot of data by the diver. Instead of this, it may be sufficient that the diver touches the device (for instance a touchscreen thereof) and then confirms by a further actuation (for instance touching two times).

In yet another exemplary embodiment, the data communication interface of the device and/or the wireless data communication interface of the apparatus and/or the wireless data communication interface of the diving equipment may be configured for communicating with one of the other wireless data communication interfaces via the emission and detection of infrared radiation. Infrared communication is also only possible under the condition of a certain spatial vicinity between infrared emitter and infrared detector. In an embodiment, the device and/or the apparatus and/or the diving equipment may have only an infrared emitter and no infrared detector, or may have only an infrared detector and no infrared emitter, or may have both an infrared emitter and an infrared detector.

The aspects defined above and further aspects of the invention are apparent from the examples of embodiment to be described hereinafter and are explained with reference to these examples of embodiment.

The invention will be described in more detail hereinafter with reference to examples of embodiment but to which the invention is not limited.

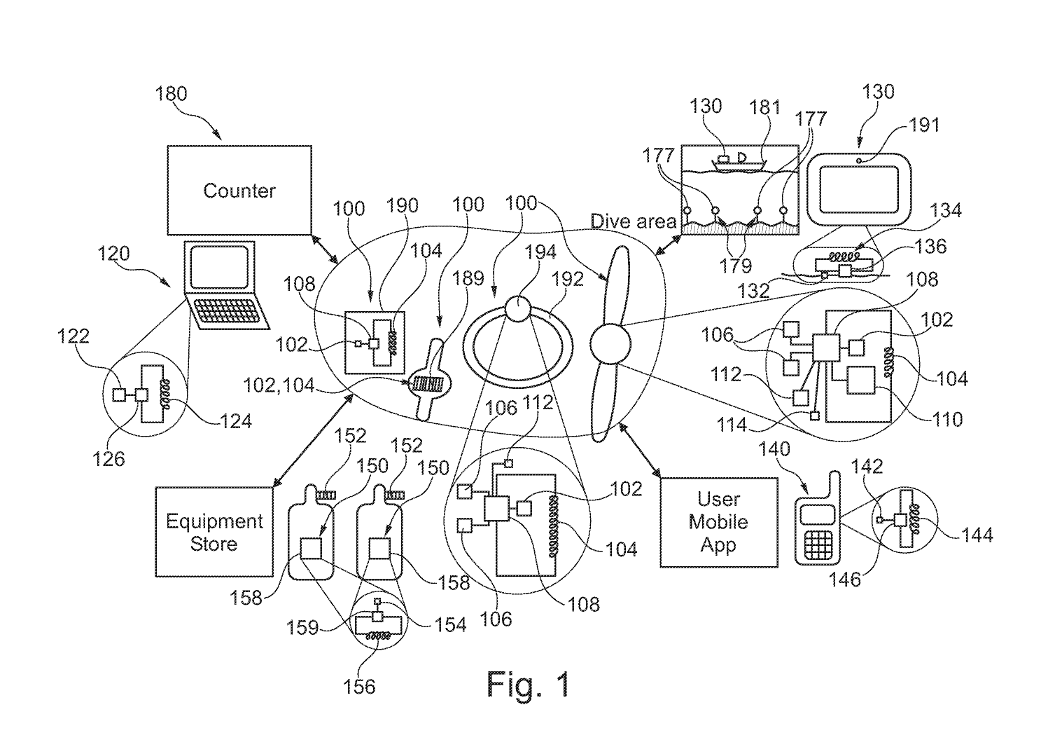

FIG. 1 illustrates an arrangement of portable diver devices, diving activities management apparatuses, and diving equipment appropriate for wirelessly transferring all dive related data to be communicated at a dive center according to an exemplary embodiment of the invention.

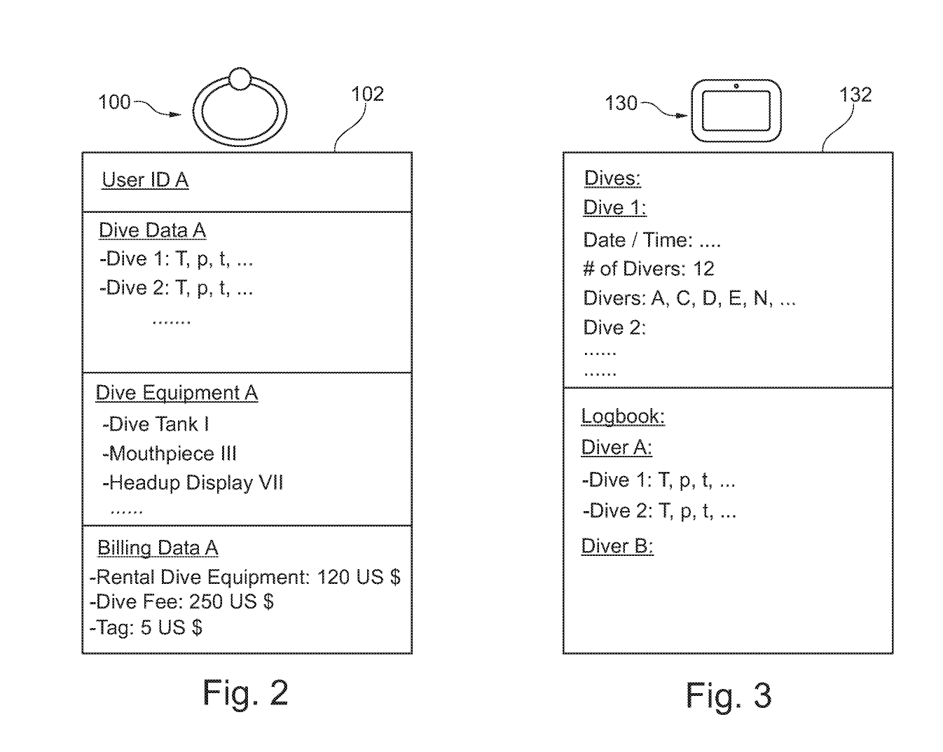

FIG. 2 illustrates schematically data stored on a data storage unit of a portable diver device according to an exemplary embodiment of the invention.

FIG. 3 illustrates schematically data stored on a database of a diving activities management apparatus on a dive excursion boat of the diving center according to an exemplary embodiment of the invention.

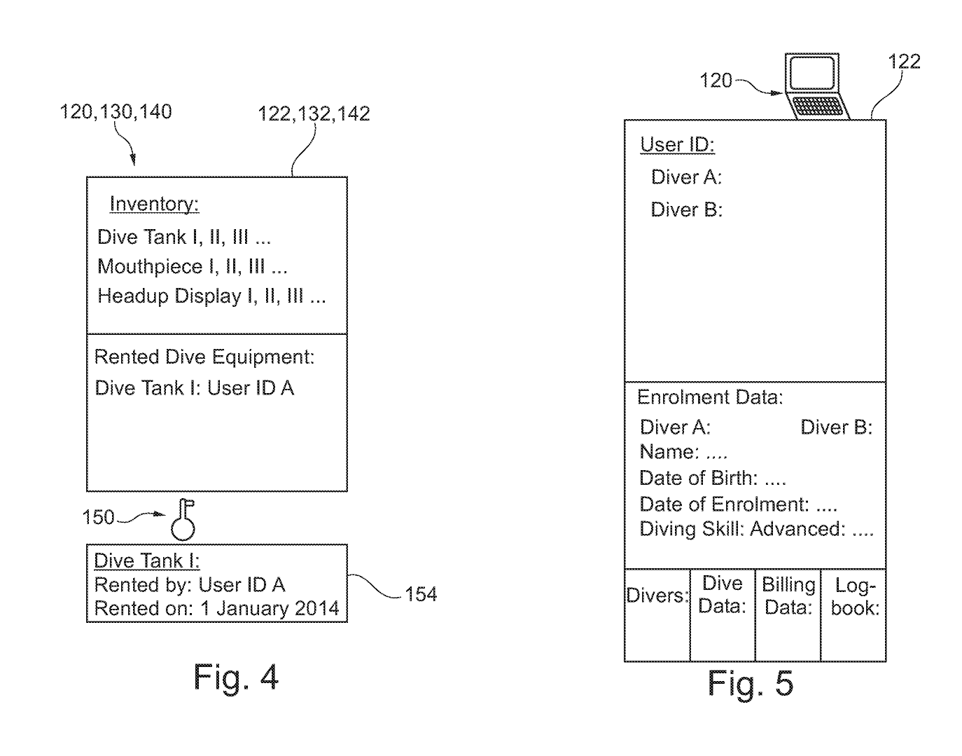

FIG. 4 illustrates schematically the data stored on a data storage unit of a tag attached to a dive equipment according to an exemplary embodiment of the invention.

FIG. 5 illustrates schematically data stored on a database of a diving activities management apparatus in an office of the diving center according to an exemplary embodiment of the invention.

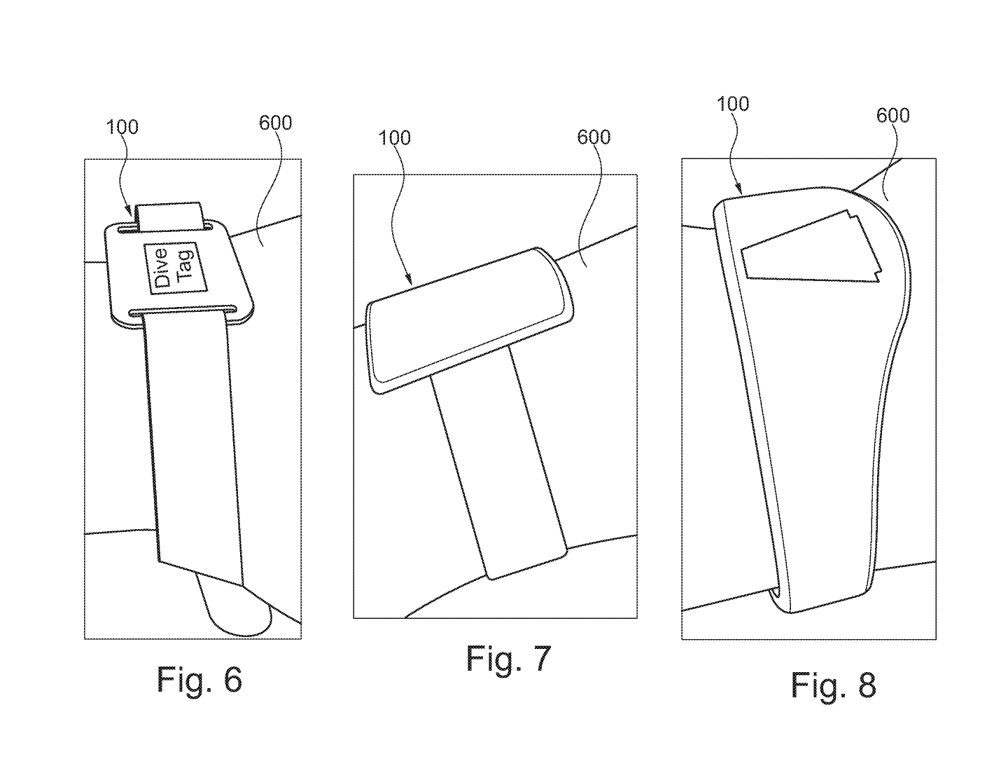

FIG. 6 to FIG. 10 illustrate portable diver devices according to different exemplary embodiments of the invention.

The illustrations in the drawings are schematical. In different drawings, similar or identical elements are provided with the same reference signs.

Before exemplary embodiments will be described with reference to the figures, some basic considerations will be summarized based on which exemplary embodiments of the invention have been developed.

According to an exemplary embodiment, a system to manage dive centers using NFC tags with both Windows® (or any other operating system, such as IOS®, Apple®, Unix®, Android®, Blackberry®) and mobile app interface is provided. Also an architecture on how to implement NFC Technology into dive loggers whether independent dive loggers or in current dive computers provided.

Conventional operations taking place in the diving centers around the world did not change much since the beginning of the industry in the late 1960s by having most of the back office work done manually on paper from registration and checking in to day to day diving operations lists to checking out and billing. While most of them are using computers to help them usually it ends up just using some of the spreadsheet programs or some software for dive center management which poorly fits their needs and being not customizable.

With the wide availability of smart phones and internet connectivity nowadays and the emergence of new technologies like the RFID and NFC that is being implemented in everyday tasks, the processes and related designed hardware according to exemplary embodiments of the invention will describe how the use of such technologies in the diving industry can increase the safety and increase the efficiency of work a lot.

Problems that a process according to an exemplary embodiment reduces or solves include:
Counting divers on a boat after each dive making sure that all divers are on the boat so no diver will be left behind;
Logging in the dives (for instance for legal purposes) after each dive (maximum depth reached, time in, time out, breathing mixture used, tank and equipment used);
Registering and checking in new divers;
Keeping record of the dive equipment (in terms of inventory, dates of maintenance, log of each piece of equipment and what has been done to it during servicing);
Providing divers with electronic logbook on their mobile device instead of the traditional log book which can get lost;
Checking out and billing;

System components which may be implemented according to exemplary embodiments include:
Software with mobile and computer interface for the dive center management;
RFID and NFC Tags using different chip types according to the need to use each chip different capability, shape of tags may be different also according to the use of each tag; such a tag may be a bracelet for the divers tag or a sticker for the equipment tag or a key chain for tanks tag;
Computers, mobile phones and tablets;
External RFID tag readers;
Pad and styles to capture signatures;
Research NFC Tag;
Mobile app for the diver to use as log book;

Examples for NFC tag types which may be used by divers according to exemplary embodiments include:
Just an NFC Tag, so that the diver can interact with the system according to his unique identifier;
A research dive logger device which the divers buy to be her or his main input method to log dive details in any of the dive loggers whether it is the dive center logbook or the personal app log book;

FIG. 1 illustrates an arrangement 180 of portable diver devices 100, diving activities management apparatuses 120, 130, 140, and diving equipment 150 appropriate for wirelessly transferring all dive related data to be communicated at a dive center according to an exemplary embodiment of the invention.

The arrangement 180 is configured for managing diving activities for a plurality of divers and comprises the diving activities management apparatuses 120, 130, 140 and the portable diver devices 100. The diving activities management apparatuses 120, 130, 140 and the portable diver devices 100 may be communicatively coupled to one another for wireless data transfer for managing diving activities for the diver. Such data communication may be enabled exclusively when a respective one of the diving activities management apparatuses 120, 130, 140 is in sufficient spatial vicinity of a respective one of the portable diver devices 100 (i.e. less than a predefined threshold value away from the respective portable diver device 100, which threshold value is defined by the communication capability of the communicatively coupled entities). Such data communication may be disabled when the entities are not in sufficient spatial vicinity (in particular when the mutual distances are larger than the threshold value).

Diving activity management apparatus 120 is configured as a laptop and can be stored at the counter of the diving center.

Diving activity management apparatus 130 is configured as a tablet (but it may alternatively be for instance a mattress over which the divers must walk when entering the boat) and it can be used in a dive area, for instance on a boat of the dive center used for making dive excursions with divers.

Diving activity management apparatus 140 is configured as a mobile phone on which an app may be stored and executed which provides the respective software support for the management procedure.

Furthermore, three examples for portable diver devices 100 are shown, each of which being assigned to a respective one of the divers. One portable diver device 100 is configured as an NFC tag (which may be carried by a user or which may be attached to a body of the user) and has a substrate 190 (such as a piece of fabric being attachable by adhesive to the user's body) with electronics embedded therein. This portable diver device 100 may store a unique identifier unambiguously authenticating the assigned user.

Another portable diver device 100 is configured as a bracelet (which can be carried around a wrist of the user) with a flexible strip 192 and an NFC chip 194. This portable diver device 100 may comprise a dive logger logging dive related data during a dive, and a unique identifier unambiguously identifying the diver.

Yet another portable diver device 100 is configured as a dive computer in form of a wrist watch (which can also be carried around the wrist of the user). This portable diver device 100 may also comprise a dive logger logging dive related data during a dive, a provision for the computation of safe dive parameters to be displayed to the diver, and the unique identifier unambiguously identifying the diver. All devices 100 are configured to be waterproof, inert with respect to saltwater and dive pressure resistant, i.e. resistant to pressure values of for instance up to 50 bar.

Each of the mentioned portable diver devices 100 is configured for managing diving activities for an assigned diver and comprises a data storage unit 102 storing unique identification data being indicative of an identity of the assigned diver and optionally storing diving related data (these data may however also be stored in a separate memory) related to the assigned diver. Each of the mentioned portable diver devices 100 comprises a wireless data communications interface 104 configured for wirelessly communicating the identification data and the diving related data with a respective one of the diving activities management apparatuses 120, 130, 140. A data communication between one of the portable diver devices 100 and one of the diving activities management apparatuses 120, 130, 140 is automatically initiated when the respective portable diver device 100 is brought in sufficient spatial vicinity of the respective diving activities management apparatus 120. By bringing the entities 120, 130, 140/100 closer to one another, execution of an NFC-based communication protocol is activated (in a specific embodiment, the communication is only enabled by a user carrying a device 100 and touching the respectively selected destination apparatus 120, 130, 140). Upon completing a sufficient spatial approaching, a specific data transfer may be started by the diving activities management apparatus 120, 130, 140 (for instance detecting the spatial vicinity of portable diver device 100 and sending a communication message to the portable diver device 100, for instance requesting the transmission of data) or by the respective portable diver device 100 (for instance detecting the spatial vicinity of diving activities management apparatus 120, 130, 140 and sending a communication message to the diving activities management apparatus 120, 130, 140, for instance transmitting data). The user-defined approach (of even touch) action which can be used by the user to intentionally trigger the data transfer is reliable and provides a high degree of data safety, since it is up to the user to decide which apparatus 120, 130, 140 is approached (or even touched) which is a requirement to enable the data to be transferred.

While the device 100 configured as NFC tag does not comprise any sensors in the shown embodiment, the device 100 configured as bracelet and the device 100 configured as dive computer comprise sensors 106 configured for sensing pressure, temperature and other dive related data during a dive under water. The device 100 configured as dive computer furthermore comprises a processor 108 for processing the sensed data and for displaying a result of the processing on a display 110 such as an LCD display. Although the device 100 configured as bracelet may also comprise a processor 108, this processor 108 only organizes data transfer via the wireless communication interface 104 without displaying results of the processing to a user. Also the device 100 configured as NFC tag may comprise such a simple processor 108.

The device 100 configured as NFC tag may be free of an active energy supply such as a battery in the shown example, but may have in another embodiment also an energy supply in form of a battery.

In contrast to this, the devices 100 configured as bracelet and dive computer also comprise a rechargeable accumulator 112 configured for supplying components of the respective device 100 with electric energy. The rechargeable accumulator 112 is also rechargeable by a respective one of the apparatuses 120, 130, 140 via the wireless data communications interface 104. A charging procedure may be initiated automatically when the device 100 is in sufficient spatial vicinity of the apparatus 120, 130, 140 (or only when a user carrying the device 100 touches the respective diving activities management apparatus 120, 130, 140). The charging procedure and the data transfer procedure may be performed either simultaneously or independently from one another, i.e. sequentially.

In addition to the rechargeable accumulator 112, the device 100 configured as a dive computer furthermore comprises an additional substitutable accumulator 114 being configured for supplying electric energy to the device 100 and for being substituted by a user when discharged. Thus, a dual power configuration is achieved by the redundant provision of the rechargeable accumulator 112 and the substitutable accumulator 114. When one of them is empty and is temporarily incapable of supplying electric energy to the components of the device 100, the respectively other one can still work as a power source. This increases the operation safety.

The constitution of the diving activities management apparatuses 120, 130, 140 is quite similar. Each of the diving activities management apparatuses 120, 130, 140 is configured for managing diving activities for a plurality of divers and comprises a respective database 122, 132, 142 (which may be configured as a data storage unit) storing data sets for each of the divers, wherein each data set comprises at least identification data being indicative of an identity of the respective diver and assigned diving related data related to the respective diver.

Each of the diving activities management apparatuses 120, 130, 140 furthermore comprises a wireless data communications interface 124, 134, 144 configured for wirelessly communicating the identification data and/or the diving related data with a respective one of the plurality of portable diver devices 100 (each assigned to a respective one of the divers) when the above-described vicinity criterion or requirement is fulfilled.

A respective processor 126, 136, 146 of each of the diving activities management apparatuses 120, 130, 140 is configured for processing the stored and the communicated data for managing the diving activities for the plurality of divers.

More specifically, the processors 126, 136, 146 of the diving activities management apparatuses 120, 130, 140 are each configured for performing one or more of the following operations:
determining whether each diver of a group of divers has communicated its presence, in particular after a dive, via the wireless data communications interface 124, 134, 144;
determining billing data for a respective diver being indicative of an amount of money to be paid for the diver's diving activities;
determining a dive protocol for a respective diver being indicative of dive parameters of the at least one dive of the diver;
determining a list of dive equipment 150 supplied to a respective diver;
processing enrolment data of a diver for enrolling the diver;
generating and assigning the identification data to the diver and communicating the assigned identification data to the portable diver device 100 to be stored on the data storage unit 102 of the portable diver device 100.

At the counter, a diver may check in the dive center. By a data communication between the device 100 (which may be delivered to the diver at the counter when enrolling) and the apparatus 120, a unique identifier generated and assigned to the user is wirelessly transmitted to and stored in the data storage unit 102 of the respective device 100. The user may be requested to wear the device 100 on her or his body during the entire stay of the user at the dive center. All diver needs can be managed at the counter (such as transport, dive site requests, etc.) using the unique identifier. It is also possible at the counter to make a bill according to the user activities which a respective diver makes during her or his stay at the dive center and may be signed using the NFC identifier.

At an equipment store the history of the presence of each individual equipment piece can be tracked. The equipment may be rented using NFC identifiers. More specifically, each piece of diving equipment 150 of the equipment store (FIG. 1 shows the example of tagged dive tanks as diving equipment 150) which may be rented to a diver may be equipped with a capability of wirelessly communicating data with a device 100 when the user wishes to rent the respective piece of diving equipment 150.

Each piece of diving equipment 150 comprises a functional dive component 152 (a dive tank in the shown embodiment) providing a dive related function during a dive of the diver. A tag 158 having a wireless data communications interface 156 may be attached to the functional dive component 152. The tag 158 furthermore comprises a data storage unit 154 storing identification data being indicative of an identity of the diving equipment 150 itself and storing identification data being indicative of an identity of the diver presently possessing the piece of dive equipment 150. Necessary processing tasks of the tag 158 may be made by a processor 159. The wireless data communications interface 156 (for instance an NFC interface) is configured for wirelessly communicating the identification data (of itself and/or of the diver) with one of the diving activities management apparatuses 120, 130, 140 or a portable diver device 100, when the respective diving activities management apparatus 120, 130, 140 or the portable diver device 100 is in sufficient spatial vicinity of the diving equipment 150. For instance, for renting the diving equipment 150, it is sufficient that the diver carrying the device 100 storing her or his identification data approaches the tag 158 of the diving equipment 150 up to less than for instance 5 cm which initiates transfer of the identification data between tag 158 and device 100. The identification data of the user and the rented dive equipment 158 may then be exchanged between the tag 158 and the device 100. In case of an apparatus 120, 130 or 140 being present in sufficient close vicinity, the identification data may also be transferred to such an apparatus 120, 130 or 140 so that the rental procedure is properly documented.

A renting procedure according to another exemplary embodiment is as follows: A dive equipment 150 such as a dive tank is equipped with a tag having an NFC chip. A diver carries a device 100 with her or his ID. An apparatus 120, 130, 140, such as a tablet PC, scans the dive equipment 150 by a wireless data exchange. The apparatus 120, 130, 140 also scans the device 100 of the diver wishing to rent the dive equipment 150 by a wireless data exchange. Hence, the apparatus 120, 130, 140 can assign the identity of the diver (based on the scanned ID) to the identity of the dive equipment 150 (obtained by scanning).

In the dive area, a diver may scan himself by NFC using the device 100 as a basis for the estimation of “time in” and “time out”. Here, tank details may be put in, a Nitrox log may be filled, etc. Via the user mobile app, it is possible to transfer the dive log from the devices 100 by touching it with the mobile phone.

Reference is now made to a drawing in FIG. 1 relating to the dive area. Apparatus 130 may be on board of a boat 181 on which divers presently make a dive trip. Underwater, the divers (not shown) dive along a dive route which is defined by a sequence of markers 179. Each of the markers 179 has an NFC chip with a corresponding wireless data communications interface 177. A wireless data communications interface 104 of a device 100 carried by a diver during the dive is configured for wirelessly communicating with the wireless data communications interfaces 177 of the plurality of dive route indicating markers 179 arranged along the dive route so that, when a diver carrying the portable device 100 is in sufficient spatial vicinity of, in particular touches, a corresponding one of the markers 179, dive route information is transmitted under water from the wireless data communications interface 177 of the respective marker 179 to the wireless data communications interface 104 of the device 100. The communicated data may be indicative of a position of the respective marker 179 along the dive route. Processor 108 of the device 100 is configured for processing the communicated dive route information for presenting the result of the processing to the diver via a display 110. Thus, a map corresponding to the dive route showing all the markers 177 and the present position of the diver may be displayed in real-time to the diver during the dive.

In the following, a further example of the device 100 according to an exemplary embodiment will be explained. FIG. 1 shows another device 100, here configured as a bracelet. The data storage unit 102 and the wireless data communications interface 104 of this device 100 are configured as an optically readable structure 189, more precisely a one-dimensional barcode encoding the identification data and the diving related data. Hence, an optical reader 191 (forming part of the wireless communication interface 134) of the diving activities management apparatus 130 (wherein the optically reader 191 is here configured as a camera of the tablet PC in combination with a processor thereof and an optical reading software) is capable of optically reading the identification data and/or the diving related data from the one-dimensional barcode, when the optically readable structure 189 is in sufficient spatial vicinity of the optical reader 191 so that the optical reading procedure can be carried out. For example, when a group of divers returns from a dive excursion, each of the divers carrying the device 100 with a user specific optically readable structure 189 approach the apparatus 130 and scan the optically readable structure 189 by the optical reader 191. The apparatus 130 can hence determine whether all divers returned safely.

In the shown example of FIG. 1, the device 100 carrying the optically readable structure 189 stores the data on a permanently printed physical structure. However, it is also possible to flexibly generate the optically readable structure 189 electronically by a processor of a dive computer as an example for another device 100 to display it on a display 110 thereof.

FIG. 2 illustrates schematically the data stored on a data storage unit 102 of a portable diver device 100 according to an exemplary embodiment of the invention.

At least one of the following data items concerning the user A may be stored in the data storage unit 102 of the device 100:
the unique identifier of user A (User ID A)
dive data for each dive (1, 2, . . . ) such as temperature (T), pressure (p), timing data (t) (Dive Data A)
a list of rented dive equipment in the possession of user A, i.e. dive tank I, mouthpiece III, headup display VII (Dive Equipment A)
billing data for the rental of dive equipment, fees for diving, and a fee for the provision of the tag or other device 100 to user A (Billing Data A)

FIG. 3 illustrates schematically the data stored on a database 132 of a diving activities management apparatus 130 on a dive excursion boat of the diving center according to an exemplary embodiment of the invention.

At least one of the following data items concerning many users A, B, . . . may be stored in the data storage unit 132 of the apparatus 130:
dive related data for each dive (1, 2, . . . ) including date and time, number of divers, identity of divers, etc. (Dives)
a dive logbook for each diver A, B, . . . including the corresponding data (T, p, t, . . . ) for each dive (1, 2)

FIG. 4 illustrates schematically the data stored on a data storage unit 154 of a tag 158 attached to a dive equipment 150 according to an exemplary embodiment of the invention.

At least one of the following data items concerning the rental procedure of the dive equipment 150 by user A may be stored:
the unique identifier of the dive equipment 150 (Dive Tank I)
the unique identifier of user A (User ID A) who rented the dive equipment 150
date of rent

At least one of the following data items concerning the entire dive equipment of the dive center may be stored in a database 122, 132 or 142 of an apparatus 120, 130 or 140:
an inventory of each and every dive equipment such as dive tanks (I, II, III), mouthpieces (I, II, III), head-up displays (I, II, III), etc. (Inventory)
a list of dive equipment rented to specific users, for instance indicating that user A is in possession of dive tank I (Rented Dive Equipment)

FIG. 5 illustrates schematically the data stored on a database 122 of a diving activities management apparatus 120 in an office of the diving center according to an exemplary embodiment of the invention.

At least one of the following data items concerning many users A, B, . . . may be stored in the data storage unit 122 of the apparatus 120:
a list of the unique identifiers for the various users A, B, . . . (User ID)
enrolment data (such as name, date of birth, date of enrolment, diving skill level, etc.) for the various users A, B, . . .
other data, for instance as described above (Dive, Dive Data, Billing Data, Logbook, Inventory, etc.)

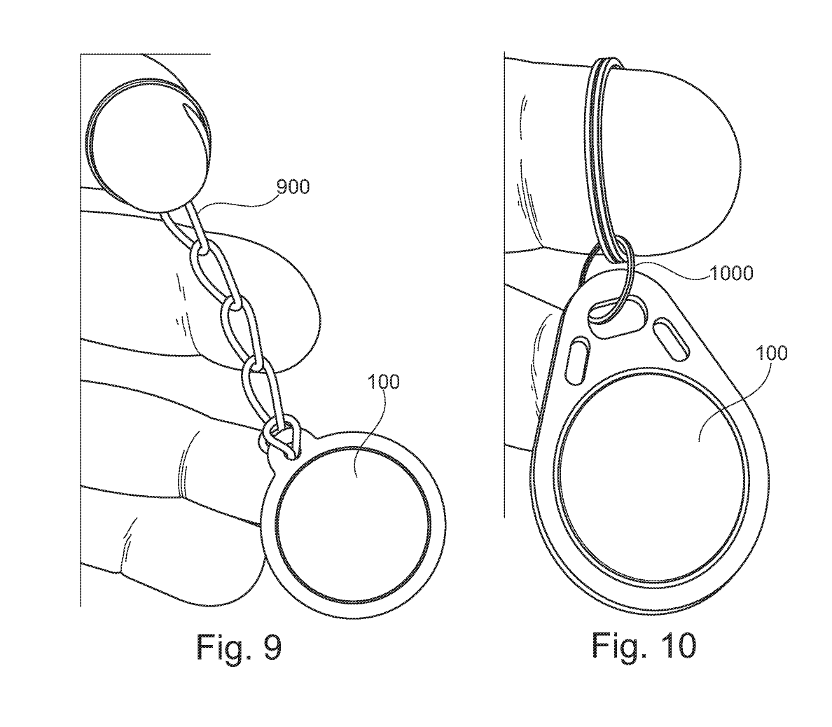

FIG. 6 to FIG. 10 illustrate portable diver devices 100 according to different exemplary embodiments of the invention. FIG. 6, FIG. 7 and FIG. 8 show bracelets as embodiments of devices 100 worn around a wrist 600 of a user. FIG. 9 shows a device 100 embodied as an NFC tag on a chain 900. FIG. 10 shows a device 100 embodied as an NFC tag on a key chain 1000.

In the following, a complete procedure as may be carried out by exemplary embodiments of the invention will be explained:

In a first stage, divers may arrive to check in and may carry a normal passport or an electronic passport for identification. An NFC reader of a mobile phone or computer or an attachable NFC sender may capture data from the passport directly into the system, without the need of manual filling of forms. This saves time, cuts paper costs and is convenient for divers.

In a second stage, it may be determined whether the enrolling diver is a new member of the diving center. If yes, the system may assign a unique identifier that gets transferred to the diver personal given NFC tag which will act as personal signature to any interaction of the system. If no, a for instance disposable NFC tag may be used for every visit, so that the ID may be assigned to a new diver NFC tag. Alternatively, the user may already have a personal NFC tag, then the tag may be scanned directly into the system to check in to use the stored data.

In a third stage, the diver tag may be used as follows: it may be used as a personal signature when diving, so in terms of safety no diver will be left behind. It may be used to calculate the number of dives according to diver signatures so as to be able to accurately calculate the bill. It is possible to assign specific equipment to each diver according to an equipment tag. On each boat, there may be a tablet with NFC capability, so that divers can interact with the system on the boat tablet (or a mobile phone of a dive guide). Hence, it is possible to get connected directly using mobile data or data which can be downloaded directly into the system at the dive base, when the dive guide comes back.

It is also possible to configure the NFC tag as a more advanced research NFC tag. When configured as a bracelet, it may have an elastic strip for instance of silicon material. Furthermore, it may have an NFC chip providing pressure sensing, time sensing and temperature sensing. A data storage unit is provided to store data. A Bluetooth module may be provided to transfer dive logs. An NFC chip may be provided carrying the unique identifier for a specific diver (for instance, a dive log can also be transferred using NFC). Furthermore, a battery may be foreseen.

It is also possible to equip the device with one or more buttons which can be pushed by a diver. By pushing the button, it is possible for the user to bookmark an event (such as a gas change, a change of the partial oxygen pressure, or any other interesting event that happens) during the dive which can be defined later.

Using a research tag, a diver can use it independently to log his dive directly into his phone eliminating the need of paper logbook and can send his dive to be analyzed and help diving medicine research or share dive logs between dive buddies or use the tag to sign his dive buddy electronic logbook.

Many different kinds of NFC tags may be implemented according to exemplary embodiments. It is possible to use the above-mentioned research tags, a disposable diver NFC tag (having only an NFC chip), a tank tag, a diving equipment tag, or a box tag. NFC tags usable for exemplary embodiment of the invention may have different types of NFC chips, for instance 1K chip, NTAG 203 chip, Ultralight, Ultralight C, NTAG203, Mifare 1 k, Desfire 4 k, Topaz 512, NTAG 210, NTAG 213, etc. Different shapes of such NFC tags are possible, such as mounted on a bracelet, as an NFC sticker, as an NFC card, as a keychain, etc.

Coming back to the above described research tag, it is possible that it starts recording the dive once under certain depth for instance 0.5 m. It locks values every two seconds and has a time in and time out looking capability.

A diver mobile app may act as a log book. It is possible to use GPS in the mobile app to pinpoint the dive site. It is possible to share such data with other users, for instance on social media.

It should be noted that the term “comprising” does not exclude other elements or steps and the “a” or “an” does not exclude a plurality. Also elements described in association with different embodiments may be combined.

It should also be noted that reference signs in the claims shall not be construed as limiting the scope of the claims.

Implementation of the invention is not limited to the preferred embodiments shown in the figures and described above. Instead, a multiplicity of variants are possible which use the solutions shown and the principle according to the invention even in the case of fundamentally different embodiments.

1. A portable diver device for managing diving activities for a diver, the portable diver device comprising:
at least one data storage unit storing identification data being indicative of an identity of the diver and optionally storing diving related data related to the diver;
and a wireless data communications interface configured for wirelessly communicating at least one of the group consisting of the identification data and the diving related data, with a diving activities management apparatus when the portable diver device is in sufficient spatial vicinity of the diving activities management apparatus.

2. The device of claim 1, wherein the wireless data communications interface is configured for wirelessly communicating the data by one of the group consisting of Near Field Communication, Radio Frequency Identification, and infrared communication.

3. The device of claim 1, configured to be wearable by or attachable to the diver.

4. The device of claim 1, configured as one of the group consisting of a tag such as an NFC tag or an RFID tag, a bracelet, a watch, and a dive computer.

5. The device of claim 1, configured to be waterproof and dive pressure resistant.

6. The device of claim 1, comprising at least one sensor configured for sensing dive related data during a dive of the diver and for storing the sensed data in the data storage unit.

7. The device of claim 6, comprising a processor configured for processing the sensed data and for presenting the result of the processing to the diver via a display of the device.

8. The device of claim 1, comprising a rechargeable accumulator being configured for supplying electric energy to the device and for being wirelessly charged with electric energy from the apparatus, in particular via the wireless data communications interface, wherein a charging procedure is initiated when the device is in sufficient spatial vicinity of the apparatus, in particular by a user carrying the device and touching the diving activities management apparatus.

9. The device of claim 8, comprising an additional substitutable accumulator being configured for supplying electric energy to the device and for being substituted when discharged.

10. The device of claim 1, wherein the wireless data communications interface is configured for enabling the wireless communication with the diving activities management apparatus only when a distance between the portable diver device and the diving activities management apparatus has fallen below a predefined threshold value, in particular has fallen below 10 cm, more particularly has fallen below 5 cm.

11. The device of claim 1, wherein the wireless data communications interface is configured for wirelessly communicating with wireless data communications interfaces of a plurality of dive route indicating markers to be arranged along a dive route so that, when a diver carrying the portable device is in sufficient spatial vicinity of, in particular touches, a corresponding one of the markers, dive route information is transmitted from the wireless data communications interface of the respective marker to the wireless data communications interface of the device; wherein the device comprises a processor configured for processing the communicated dive route information for presenting the result of the processing to the diver via a display.

12. The device of claim 1, wherein the data storage unit and the wireless data communications interface are configured as an optically readable structure, in particular a barcode or a QR code, encoding the identification data and the diving related data so that an optical reader of the diving activities management apparatus is capable of optically reading at least one of the identification data and the diving related data, when the optically readable structure is in sufficient spatial vicinity of the optical reader.

13. A diving activities management apparatus for managing diving activities for a plurality of divers, the diving activities management apparatus comprising:
a database storing data sets for each of the divers, wherein each data set comprises identification data being indicative of an identity of the respective diver and assigned diving related data related to the respective diver;
a wireless data communications interface configured for wirelessly communicating at least one of the group consisting of the identification data and the diving related data with a plurality of portable diver devices, each assigned to a respective one of the divers, when the respective portable diver device is in sufficient spatial vicinity of the diving activities management apparatus; and
a processor configured for processing the stored and the communicated data for managing the diving activities for the plurality of divers.

14. The apparatus of claim 13, wherein the wireless data communications interface is configured for wirelessly communicating the data by one of the group consisting of Near Field Communication, Radio Frequency Identification, optically reading, and infrared communication.

15. (canceled)

16. The apparatus of claim 13, wherein the processor is configured for at least one of the group consisting of:
determining whether each diver of a group of divers has communicated its presence, in particular after a dive, via the wireless data communications interface;
determining billing data for a respective diver being indicative of an amount of money to be paid for the diver's diving activities;
determining a dive protocol for a respective diver being indicative of dive parameters of the at least one dive of the diver;
determining a list of dive equipment supplied to a respective diver;
processing enrolment data of a diver for enrolling the diver;
generating and assigning the identification data to the diver and communicating the assigned identification data to the portable diver device to be stored on the data storage unit of the portable diver device.

17. The apparatus of claim 12, wherein the wireless data communications interface comprises or consists of an optical reader capable of optically reading at least one of the identification data and the diving related data from an optically readable structure, in particular a barcode or a QR code, of a respective one of the plurality of portable diver devices when the optically readable structure is in sufficient spatial vicinity of the optical reader.

18-24. (canceled)

25-26. (canceled)

27. A method of managing diving activities for a plurality of divers, the method comprising:
storing data sets for each of the divers in a database of a diving activities management apparatus, wherein each data set comprises identification data being indicative of an identity of the respective diver and assigned diving related data related to the respective diver;
wirelessly communicating at least one of the group consisting of the identification data and the diving related data between a wireless data communications interface of the diving activities management apparatus and a plurality of portable diver devices each assigned to a respective one of the divers, when the respective portable diver device is in sufficient spatial vicinity of the diving activities management apparatus; and
processing the stored and the communicated data by a processor of the diving activities management apparatus for managing the diving activities for the plurality of divers.

28. The method of claim 27, wherein the wireless communication of data is performed by one of the group consisting of Near Field Communication, Radio Frequency Identification, and optically reading.

29. The method of claim 25, wherein the method comprises using the communicated data for at least one of the group consisting of an electronic log book, research, and sharing them via a social network.

30-31. (canceled)

32. The method of claim 27 further comprising:
storing identification data being indicative of an identity of the diver and storing diving related data related to the diver on a data storage unit of a portable diver device; and
wirelessly communicating at least one of the group consisting of the identification data and the diving related data between a wireless data communications interface of the portable diver device and a diving activities management apparatus when the portable diver device is in sufficient spatial vicinity of the diving activities management apparatus.
